(19) United States
(12) Patent Application Publication
(10) Pub. No.: US 2022/0044315 A1
(43) Pub. Date: Feb. 10, 2022

(54) Use of Brokered Financial Institution Deposits During Financial Institution Sweeps

(71) Applicant: Wells Fargo Bank, N.A., San Francisco, CA (US)

(72) Inventor: Sunil Kothapalli, Marvin, NC (US)

(21) Appl. No.: 16/220,315

(22) Filed: Dec. 14, 2018

Related U.S. Application Data
(63) Continuation of application No. 14/844,852, filed on Sep. 3, 2015, now abandoned.

(51) Int. Cl. G06Q 40/04; G06Q 20/22

(52) U.S. Cl. CPC G06Q 40/04; G06Q 20/29

(57) ABSTRACT

A brokerage sweep account amount and a brokered financial institution account amount are identified for a client. The brokered financial institution account for the client pays a higher interest rate than the brokerage sweep account and the brokered financial institution account pays a higher interest rate than a standard savings account. A request is received to purchase a security for a first dollar amount. When the brokerage sweep account amount for the client is not equal to or greater than the first dollar amount: the brokerage sweep account amount for the client is used as a partial payment for the security; a second dollar amount is automatically obtained from the brokered financial institution account for the client to fund a remainder of the first dollar amount; and the second dollar amount is used to pay for a remainder of the security.

### BACKGROUND

The Federal Deposit Insurance Corporation (FDIC) provides deposit insurance guaranteeing the safety of depositor's accounts at financial institutions that are insured by the FDIC. The depositor's accounts are insured up to an FDIC limit, currently $250,000, for each deposit ownership category at an FDIC member financial institution. Some examples of deposit ownership categories include individual accounts, joint accounts, certain retirement accounts, revocable trust account and irrevocable trust accounts.

Investors commonly make use of brokerage sweep accounts to earn interest on cash earmarked for brokerage investments. In a sweep program, cash in a brokerage sweep account can be transferred to a money market deposit account or similar type of account where the cash can earn interest. When the cash is transferred to an FDIC member financial institution, depending on an amount that is transferred, all or part of the cash that is transferred can be insured by the FDIC.

### SUMMARY

Embodiments of the disclosure are directed to an electronic computing device comprising: a processing unit; and system memory, the system memory including instructions which, when executed by the processing unit, cause the electronic computing device to: identify a brokerage sweep account amount for a client; identify a brokered financial institution account amount for the client, the brokered financial institution account for the client paying a higher interest rate than the brokerage sweep account and the brokered financial institution account paying a higher interest rate than a standard savings account; receive a request to purchase a security for a first dollar amount; determine whether the brokerage sweep account amount for the client is equal to or greater than the first dollar amount; when the brokerage sweep account amount for the client is not equal to or greater than the first dollar amount: use the brokerage sweep account amount for the client as a partial payment for the security; automatically obtain a second dollar amount from the brokered financial institution account for the client to fund a remainder of the first dollar amount; and use the second dollar amount to pay for a remainder of the security.

In another aspect, a computer-readable data storage memory includes instructions that, when executed by a processing unit of an electronic computing device, cause the processing unit to: identify a brokerage sweep account amount for a client; receive a deposit for a brokered financial institution account for the client, the brokered financial institution account for the client paying a higher interest rate than the brokerage sweep account and the brokered financial institution account paying a higher interest rate than a standard savings account; receive a request to purchase a security for a first dollar amount; determine whether the brokerage sweep account amount for the client is equal to or greater than the first dollar amount; when the brokerage sweep account amount is equal to or greater than the first dollar amount, use the brokerage sweep account amount to purchase the security; when the brokerage sweep account amount is less than the first dollar amount: obtain a first subtraction amount by subtracting the brokerage sweep account amount from the first dollar amount; determine whether the brokerage financial institution account amount is greater than or equal to the first subtraction amount; and when the brokerage financial institution account amount is greater than or equal to the first subtraction amount: subtract an amount equal to the first subtraction amount from the brokerage financial institution account; and use a sum of the first subtraction amount and the brokerage sweep account amount to purchase the security.

In yet another aspect, a method includes: a computer-readable data storage memory comprising instructions that, when executed by a processing unit of an electronic computing device, cause the processing unit to: identify a brokerage sweep account amount for a client; identify a brokered financial institution account amount for the client, the brokered financial institution account for the client paying a higher interest rate than the brokerage sweep account and the brokered financial institution account paying a higher interest rate than a standard savings account; receive a request to purchase a security for a first dollar amount; determine whether the brokerage sweep account amount for the client is equal to or greater than the first dollar amount; when the brokerage sweep account amount for the client is not equal to or greater than the first dollar amount, use the brokerage sweep account amount for the client as a partial payment for the security; automatically obtain a second dollar amount from the brokered financial institution account for the client to fund a remainder of the first dollar amount; use the second dollar amount to pay for a remainder of the security; at the end of a business day, transfer cash in the brokerage sweep account to one or more chartered financial institutions; determine whether a total amount of the cash transferred is less than $750,000; and when a determination is made the total amount of the cash transferred is less than $750,000: determine a third dollar amount equal to a difference between the brokered financial institution account amount and $750,000; receive a request to withdraw the third dollar amount from the brokered financial institution account; and transfer the third dollar amount to one or more of the chartered financial institutions, wherein the third dollar amount is distributed between the chartered financial institutions such that a sum of deposits at each of the chartered financial institutions do not exceed $250,000.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that can be used to implement a use of brokered financial institution deposits during financial institution sweeps.

FIG. 2 shows an example of initial balances of customer cash at the chartered financial institutions of FIG. 1.

FIG. 3 shows an example of customer cash balances at the chartered financial institutions of FIG. 1.

FIG. 4 shows another example of customer balances at the chartered financial institutions of FIG. 1.

FIG. 5 shows yet another example of customer balances at the chartered financial institutions of FIG. 1.

FIG. 6 shows yet another example of customer balances at the chartered financial institutions of FIG. 1.

FIG. 7 shows yet another example of customer balances at the chartered financial institutions of FIG. 1.

FIG. 8 shows a flowchart of an example method for purchasing a security using cash from a financial institution sweep account and a brokered financial institution account.

FIG. 9 shows example physical components of a chartered financial institution computer system of FIG. 1.

### DETAILED DESCRIPTION

The present disclosure is directed to systems and methods for using brokered financial institution deposits to provide a higher interest rate to clients than can be obtained using financial institution sweeps. The brokered financial institution deposits are cash amounts that are generally manually deposited, typically by a financial advisor, into a brokered financial institution account. The brokered financial institution account is a financial institution account that can earn a higher interest rate than a standard financial institution savings account but that provides less risks or restrictions than money market funds, certificates of deposits or other similar types of investments.

As used in this disclosure, a brokerage sweep account is an account that a customer of a financial institution can use to deposit cash that is typically earmarked for security purchases. At the end of a business day, the cash in the brokerage sweep account is automatically transferred to an interest earning account, for example a money market fund, so that the cash can earn interest. At the start of the next business day, the cash is automatically transferred back to the brokerage sweep account. A process for automatically transferring cash from the brokerage sweep account to the interest earning account is commonly known as a financial institution sweep. In some implementations, a certain predetermined cash amount is kept in the brokerage sweep account and cash amounts greater than the predetermined cash amount are transferred to the interest earning account. In this disclosure, the terms client and customer can be used interchangeably.

The brokered financial institution account can be used when cash amounts in the brokerage sweep account may be too high. For example, if the customer recently sold a business and received a large amount of cash, for example $20 million, and the customer wants to receive a higher interest rate for the cash that can be obtained in the brokerage sweep account, the customer can deposit some or all of the cash in the brokered financial institution account.

The brokered financial institution account differs from other high interest accounts such as a certificate of deposit or a money market fund, in that the brokered financial institution account does not have the time restrictions of a certificate of deposit and does not have some of the risks associated with a money market fund. However, for the brokered financial institution account described in this disclosure, in order to obtain the higher interest rate offered for the brokered financial institution account, a minimum deposit amount is required. In an example implementation, an initial deposit to the brokered financial institution account needs to be a minimum of $5,000,000 and subsequent deposits need to be a minimum of $1,000,000. Other initial and subsequent minimum amounts are possible.

As used in this disclosure, most deposits and withdrawals to the brokered financial institution account are made manually, typically by a financial advisor, with the consent of the client. An exception is when the brokered financial institution account is used as a cash reserve to provide additional funds for a security purchase, as described below herein.

Using the systems and methods, the brokered financial institution account can be used as a cash reserve for making security purchases. When a customer purchases a security and there is not enough cash in the customer's brokerage sweep account to cover the purchase, cash can be automatically withdrawn from the customer's brokered financial institution account to provide the needed cash for the purchase. For example, if the customer wishes to make a security purchase at a cost of $1 million and there is only $800,000 in the customer's brokerage sweep account, $200,000 can be automatically withdrawn from the customer's brokered financial institution account to help pay for the purchase.

The systems and methods disclosed herein can improve efficiencies for financial institutions that implement brokerage sweeps in a way that can provide a maximum benefit to customers of the financial institution. The systems and methods provide automatic access to customer accounts at a chartered financial institution and at a financial institution for the brokerage sweep accounts. These accounts can be located on a plurality of different computer systems and at a plurality of geographical locations. By automatically determining a dollar value of customer accounts at the chartered financial institution, the systems and methods can automatically determine an amount of cash to transfer to the chartered financial institution from a brokerage sweep account so that Federal Deposit Insurance Corporation (FDIC) insurance coverage is maximized for the customer.

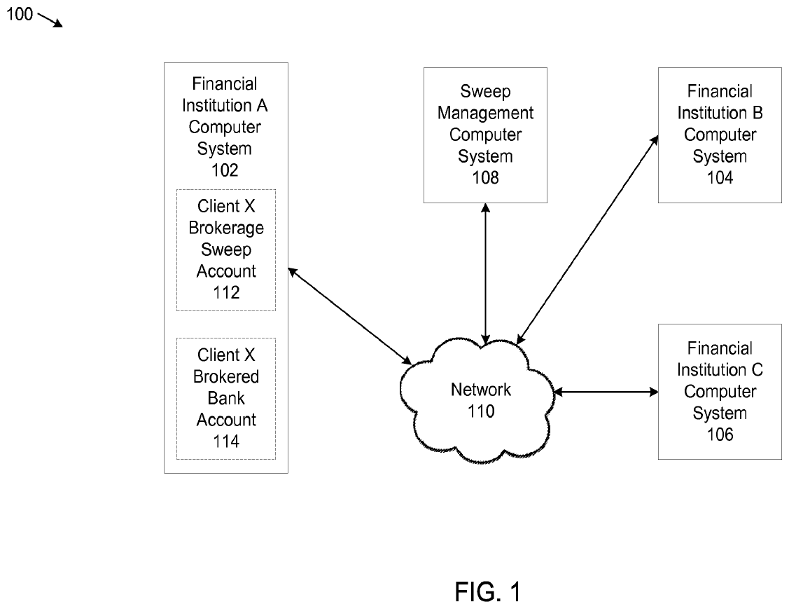

FIG. 1 shows an example system 100 that can be used to implement a brokered financial institution account with a brokerage sweep account at a financial institution. The example system 100 includes a financial institution A computer system 102, a financial institution B computer system 104, a financial institution C computer system 106, a sweep management computer system 108 and a network 110. The financial institution A computer system includes a client X brokerage sweep account 112 and a client X brokered financial institution account 114.

The example financial institution A computer system 102, the example financial institution B computer system 104 and the example financial institution C computer system 106 are computers systems at a chartered financial institution of the financial institution. The computer systems can comprise one or more electronic computing devices including one or more of desktop computers, laptop computers, tablet computers, smartphones, server computers server farms and other electronic computing devices. The computer systems can be located at a plurality of geographical locations.

As used in this disclosure, a chartered financial institution is a financial institution that has received appropriate regulatory approval to operate and/or to receive certain government guarantees, for example to be eligible for FDIC insurance. The chartered financial institutions are regulated by laws of the United States and normally receive a charter to engage in business. The charter specifies the regulations under which the financial institution must operate and comply. A chartered financial institution can have a plurality of branch offices and geographical locations. An example of a chartered financial institution is Wells Fargo Financial institution, National Association (N.A.). Two other chartered financial institutions are Wells Fargo Financial institution South Central, N.A and Wells Fargo Financial institution North West, N.A.

Currently, the FDIC deposit insurance amount is $250,000 per depositor, per insured financial institution, for each account ownership category. An insured financial institution is a chartered financial institution, as described above, herein. Ownership categories can include single account, joint accounts, certain retirement accounts, revocable trust accounts, irrevocable trust accounts, employee benefit plan accounts, corporation/partnership/unincorporated associated accounts and government accounts. By having deposits in multiple chartered financial institutions and/or by having multiple account ownership categories, a person can obtain FDIC coverage for amounts greater than $250,000. For example, if the person has deposits in three chartered financial institutions for a financial institution for a single ownership category (for example a single account), the person can obtain FDIC coverage of $750,000.

The example financial institution A computer system includes client X brokerage sweep account 112 and client X brokered financial institution account 114. The example client X brokerage sweep account 112 is an account in which client X holds cash that can be used to purchase securities. As discussed earlier herein, at the end of a business day, the cash is transferred from the client X brokerage sweep account 112 to an interest bearing account in which the cash can earn interest. At the start of the next business day, the case is transferred back to client X brokerage sweep account 112. Also as discussed herein, the client X brokered financial institution account 114 is a brokered account that provides a higher interest rate for client X cash than can is available from a standard savings account or from the interest bearing account used during a brokerage cash sweep. Cash can be deposited or withdrawn to/from the client X brokered financial institution account 114 via a manual cash transfer, for example a cash transfer initiated by a financial advisor for client X. In an exception described earlier herein, cash can also be automatically withdrawn to make up for a lack of funds in client X brokerage sweep account 112 when purchasing a security.

The example sweep management computer system 108 is a computer system that can control the transfer of funds between client X brokerage sweep account 112, client X brokered financial institution account 114 and other accounts at financial institution A computer system 102, financial institution B computer system 104 and financial institution C computer system 106. As discussed in more detail later herein, funds can be transferred to financial institution A computer system 102, financial institution B computer system 104 and financial institution C computer system 106 in such a way as to maximize FDIC coverage at financial institution A computer system 102, financial institution B computer system 104 and financial institution C computer system 106.

The example network 110 is a computer network that can comprise a corporate Intranet that can permit communications between one or more of sweep management computer system 108, financial institution A computer system 102, financial institution B computer system 104 and financial institution C computer system 106. Network 110 can also include the Internet.

During operation of system 100, a plurality of messages can be communicated among the electronic computing devices of system 100. As a result of the messages, account data for client X can be accessed at financial institution A computer system 102, financial institution B computer system 104 and financial institution C computer system 106. New account data regarding balances in client X accounts can be stored at one or more of financial institution A computer system 102, financial institution B computer system 104 and financial institution C computer system 106 and at one or more databases that can be accessed by these computer systems. The account data and other client X information can be transmitted and received over network 110 and the electronic computing devices of system 100 can access and store the account data and the other client X information at a plurality of geographical locations.

Using the systems and methods, the computer systems at the financial institutions can become more efficient. For example, the sweep management computer system 108 can have access to client X brokerage sweep account 112 and client X brokered bank account 114 at financial institution A computer system 102 and to client X financial institution accounts at financial institution A computer system 102. By having access to these accounts, the sweep management computer system 108 can efficiently access client X account data and determine how much cash in client X brokerage sweep account 112 can be transferred during a brokerage sweep. Sweep management computer system 108 can also access any client X accounts at financial institution B computer system 104 and at financial institution C computer system 106 and efficiently determine how much cash in client X brokerage sweep account 112 can be transferred to financial institution B computer system 104 and to financial institution C computer system 106.

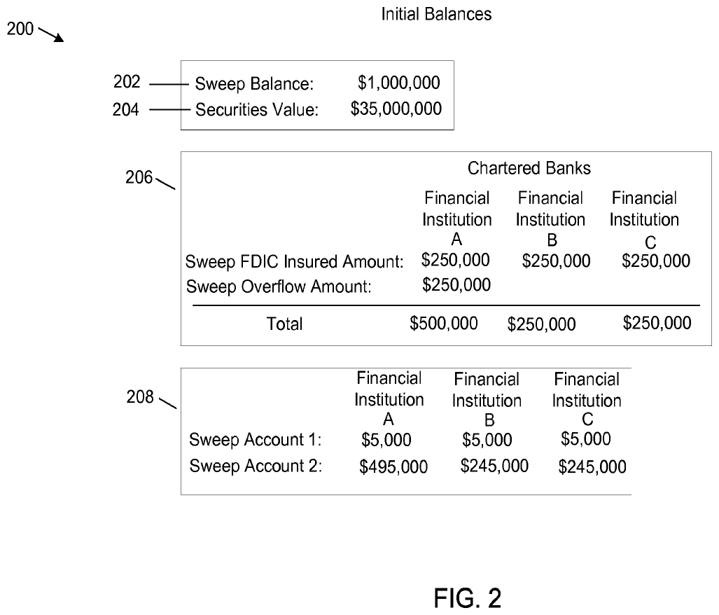

FIG. 2 shows an example 200 of initial balances of customer cash at a plurality of chartered financial institutions. As shown in FIG. 2, the customer has a sweep balance 202 of $1,000,000 and owns securities with a securities value 204 of $35,000,000.

FIG. 2 also shows an example cash distribution 206 of the sweep balance 202 cash at three chartered financial institutions—financial institution A, financial institution B and financial institution C. For example 200, financial institution A corresponds to Wells Fargo Financial institution, N.A; financial institution B corresponds to Wells Fargo Financial institution South Central, N.A; and financial institution C corresponds to Wells Fargo Financial institution North West, N.A. The example cash distribution 206 includes sweep FDIC insured amounts and non-FDIC insured sweep overflow amounts. As shown in cash distribution 206, of the $1,000,000 in the customer's sweep balance 202, $250,000 is deposited in FDIC insured accounts at each of financial institution A, financial institution B and financial institution C. Because the FDIC limit is $250,000 at each chartered financial institution, there is an overflow amount of $250,000. For cash distribution 206, the overflow amount of $250,000 is deposited in a non-FDIC insured sweep overflow account at financial institution A. In other implementations, the overflow amount may be distributed in different chartered financial institutions or in a combination of chartered financial institutions.

FIG. 2 also shows an example account distribution 208 showing how cash in each chartered financial institution is distributed among various customer accounts in the chartered financial institutions. For the example shown in FIG. 2, the customer has two cash accounts for sweep balances. In this implementation, a first cash account (sweep account 1) can be a savings account and a second cash account (sweep account 2) can be a money market account. More, fewer or different cash accounts are possible. As shown in account distribution 208, for financial institution A $5,000 is deposited in sweep account 1 and $495,000 is deposited in sweep account 2. For financial institution B, $5,000 is deposited in sweep account 1 and $245,000 is deposited in sweep account 2. For financial institution C, $5,000 is deposited in sweep account 1 and $245,000 is deposited in sweep account 2. Different distributions are possible.

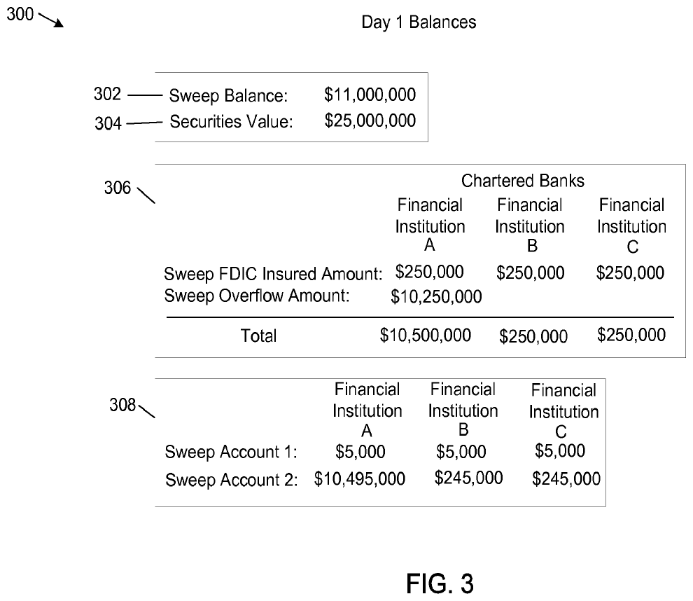

FIG. 3 shows another example 300 of customer cash balances at a plurality of chartered financial institutions. The example 300 shows the customer cash balances at a day 1 after the customer has sold $10 million of stock. As shown in FIG. 3, after the customer sells $10,000,000 in stock, the securities value 304 decreases from $35,000,000 to $25,000,000. In addition, because cash from the sale is added to the sweep balance for the customer, sweep balance 302 increases from $1,000,000 to $11,000,000.

FIG. 3 also shows an updated cash distribution 306 at the chartered financial institutions and an updated account distribution 308 among the various cash accounts at the chartered financial institutions. As shown in cash distribution 306, the non-FDIC insured sweep overflow amount at financial institution A has increased from $250,000 to $10,250,000. This is because a maximum of $750,000 of the customer's cash is already FDIC insured at the chartered financial institutions. Therefore, in this implementation, any additional cash is added to the non-FDIC insured sweep overflow at financial institution A. In other implementations, the additional cash can be added to a non-FDIC insured sweep overflow at financial institution B, financial institution C or at a combination of financial institution A, financial institution B and financial institution C.

As shown in account distribution 308, in this implementation the additional $10,000,000 of cash is added to sweep account 2 at financial institution A. In other implementations, the additional cash can be added to sweep account 2 or to other accounts at financial institution B, financial institution C or a combination of financial institution A, financial institution B and financial institution C.

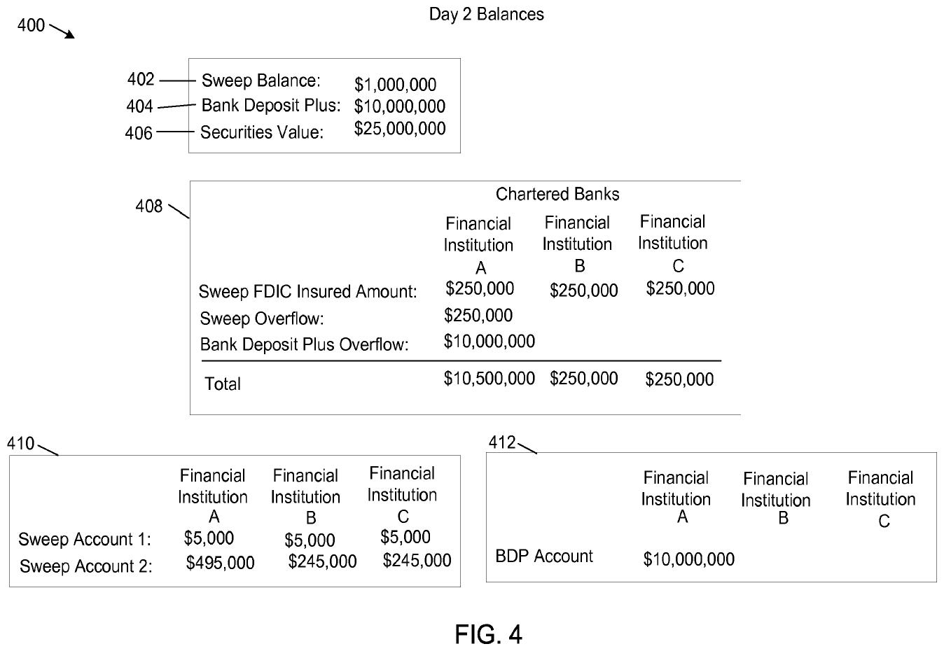

FIG. 4 shows yet another example 400 of customer cash balances at the plurality of chartered financial institutions. The example 400 shows the customer cash balances at a day 2 after a financial advisor for the customer manually transferred $10,000,000 from the customer's sweep balance 402 to the customer's brokered financial institution account. The financial advisor transferred the $10,000,000 to the customer's brokered financial institution account in order to earn a higher interest rate for the $10,000,000.

As shown in FIG. 4, the customer's brokered financial institution account is identified as financial institution deposit plus account 404. As used in this disclosure, the terms brokered financial institution account and financial institution deposit plus (BDP) account are used interchangeably. As shown in FIG. 4, after $10,000,000 is transferred to financial institution deposit plus account 404, the customer's sweep balance 402 remains at $1 million and the customer's securities value 406 remains at $25 million.

FIG. 4 also shows that a new line for financial institution deposit plus overflow has been added to the customer's cash distribution 408 at the chartered financial institutions. The financial institution deposit plus overflow amount is $10,000,000 and the previous non-FDIC insured sweep overflow is reduced by $10,000,000 to $250,000. For the account distribution 410 for sweep accounts at the chartered financial institutions, the value of sweep account 2 at financial institution A is reduced from $10,495,000 to $495,000. Instead, $10,000 is deposited in a separate BDP account at financial institution A. This can be seen in BDP cash distribution 412. For the example implementation shown in FIG. 4, the BDP account for BDP cash distribution 412 can be a money market account. Other types of BDP accounts are possible.

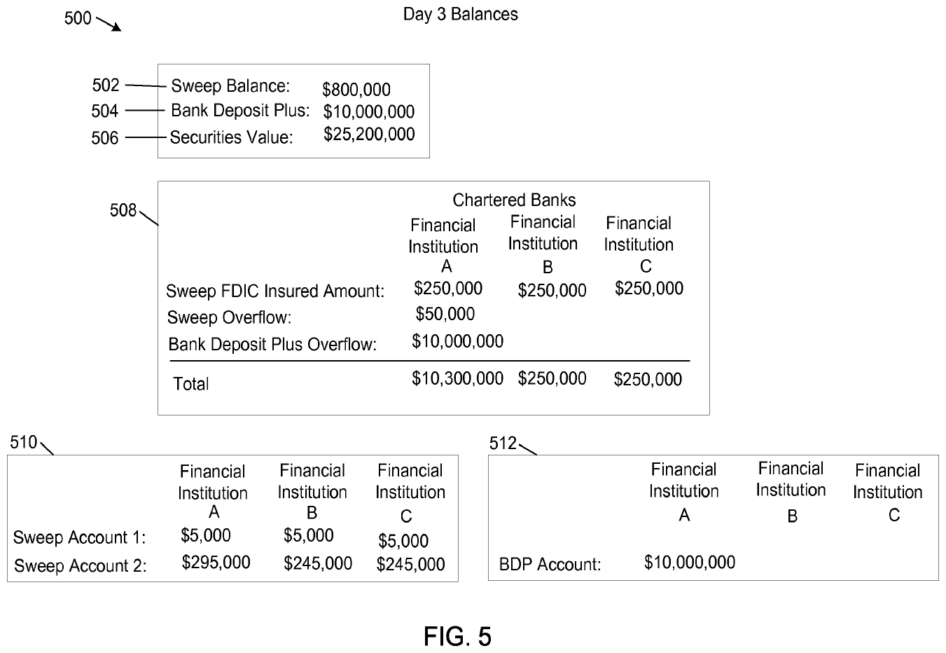

FIG. 5 shows yet another example 500 of customer cash balances at the plurality of chartered financial institutions. The example 500 shows the customer cash balances at a day 3 after the customer has purchased $200,000 of stock. The customer uses cash from sweep balance 502 to purchase the stock. After the customer purchases the stock, the sweep balance 502 is reduced from $1 million to $800,000. In addition, the securities value 506 increases from $25 million to $25,200,000. Because cash from the sweep balance 502 is used for the purchase, the financial institution deposit plus 504 balance remains at $10 million.

FIG. 5 also shows that the cash distribution 508 at the chartered financial institutions has changed as a result of the stock purchase. Because the sweep balance 502 is now $800,000, in order to preserve maximum FDIC coverage for the $800,000, as shown in cash distribution 508 the non-FDIC insured sweep overflow amount is reduced to $50,000 from $250,000. This changes the total cash for the customer at financial institution A to $10,300,000 ($250,000+$50,000+$10,000,000). The remaining $750,000 from the sweep balance 502 is still FDIC insured—$250,000 at each of financial institution A, financial institution B and financial institution C. In addition, for the customer's cash distribution 510 for accounts at the chartered financial institutions, the customer's sweep account 2 balance at financial institution A is reduced by $200,000 to $295,000 ($495,000−$200,000).

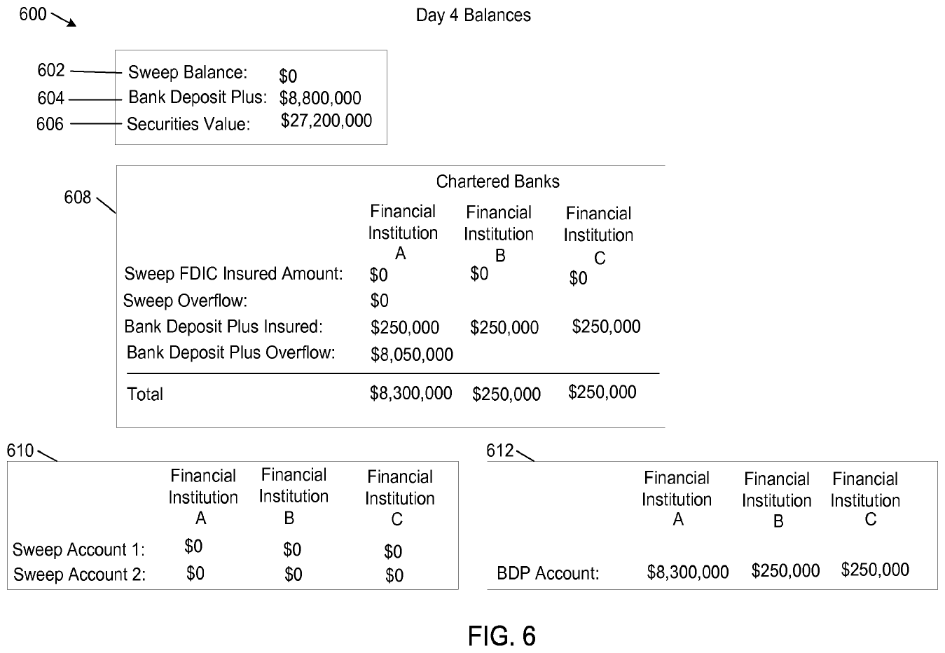

FIG. 6 shows yet another example 600 of customer cash balances at the plurality of chartered financial institutions. The example 600 shows the customer cash balances at a day 4 after the customer purchases an additional $2,000,000 of stock. The customer uses cash from sweep balance account 602 to pay for a portion of the purchase and uses additional cash from financial institution deposit plus account 604 to pay for the remaining portion of the purchase.

At the start of day 4, the customer had $800,000 in sweep balance account 602. Since the purchase price for the stock is $2,000,000, the customer needs to withdraw $1,200,000 from financial institution deposit plus account 604 to make up the difference between the $2,000,000 purchase price and the $800,000 in sweep balance account 602. In some implementations, the financial advisor manually transfers $1,200,000 from financial institution deposit plus account 604 to sweep balance account 602. In other implementations, the $1,200,000 is automatically transferred from financial institution deposit plus account 604 to sweep balance account 602. The automatic transfer of the $1,200,000 comprises an exception to the normal policy of manually withdrawing cash from the financial institution deposit plus account 604. As discussed earlier herein, the exception occurs because the cash is needed as an overdraft protection to help pay for the purchase of a security. After the purchase of the additional $2,000,000 of stock, the sweep balance account 602 has a value of zero, the financial institution deposit plus account 604 has a value of $8,800,000 ($10,000,000−$1,200,000) and the securities value 606 is $27,200,000 ($25,200,000+$2,000,000).

FIG. 6 also shows that the cash distribution 608 at the chartered financial institutions has changed as a result of the stock purchase. Because the sweep balance account 602 is now zero, the portion of sweep cash at financial institution A, financial institution B and financial institution C are now also zero. However, $750,000 of the brokered financial institution account (financial institution deposit plus account 604) is now FDIC insured—$250,000 at each of financial institution A, financial institution B and financial institution C. The financial institution deposit plus overflow at financial institution A is now $8,050,000 ($8,800,000−$750,000). In addition, for the customer's cash distribution 610 for accounts at the chartered financial institutions, because the sweep balance account 602 is now zero, the sweep account 1 balance at financial institutions A, B and C are also zero. The cash distribution 612 for the customer's BDP account now shows a balance at financial institution A of $8,300,000 ($250,000+$8,050,000) and a balance at each of financial institutions B and C of $250,000.

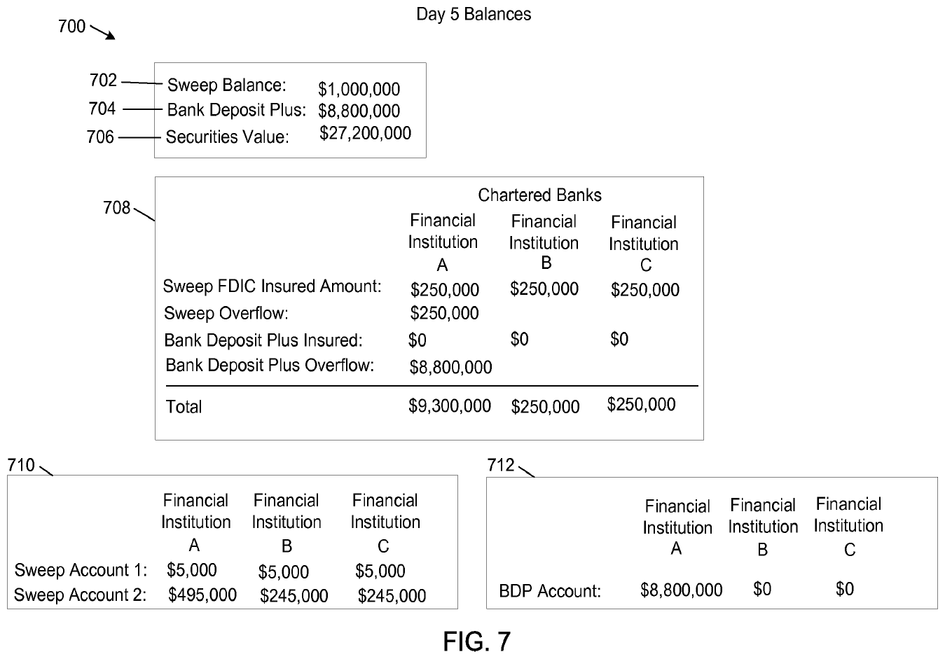

FIG. 7 shows yet another example 700 of customer cash balances at the plurality of chartered financial institutions. The example 700 shows the customer cash balances at a day 5 after the customer deposits $1,000,000 into the customer's sweep balance account 702. As a result of the deposit, the customer's sweep balance account 702 increases from zero to $1,000,000. The customer's financial institution deposit plus 704 balance remains at $8,800,000 and the customer's securities value 706 remains at $27,200,000.

FIG. 7 shows that the customer's cash distribution 708 at the chartered financial institutions has changed. Because $1,000,000 has been added to the customer's sweep balance account 702, $750,000 of the $1,000,000 is FDIC insured—$250,000 at each of financial institutions A, B and C. However, because $750,000 of the customer's sweep balance is FDIC insured and the FDIC limit has been reached for the customer's cash at financial institutions A, B and C, none of the customer's BDP cash is now FDIC insured. Instead, all of the customer's BDP cash ($8,800,000) is deposited at financial institution A as BDP overflow.

In addition, for this example the customer's sweep balance cash of $1,000,000 is deposited in two customer accounts at each of financial institutions A, B and C. FIG. 7 shows that for the customer's cash distribution 710 for accounts at the chartered financial institutions, the sweep account 1 balance at financial institutions A, B and C are each $5,000. In addition, because a total of $250,000 is FDIC insured at each of financial institutions A, B and C, $245,000 is deposited in the customer's sweep account 2 at each of financial institutions B and C ($250,000−$5,000). Furthermore $495,000 is deposited in the customer's sweep account 2 at financial institution A. Of the $495,000, $245,000 represents FDIC insured cash and $250,000 represents financial institution sweep overflow. The cash distribution 712 for the customer's BDP account now shows a balance of $8,800,000 at financial institution A and none of this cash is FDIC insured.

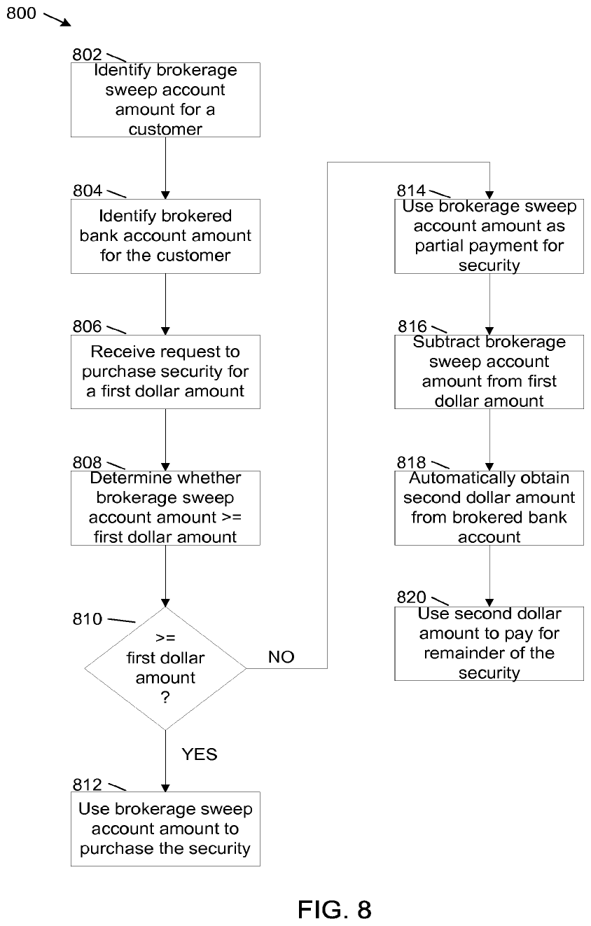

FIG. 8 shows a flowchart for an example method 800 for purchasing a security using cash from a financial institution sweep account and from a brokered financial institution account. As discussed herein, the financial institution sweep account is a cash account that is earmarked for brokerage purchases and that earns interest on automatic overnight transfers. Also as discussed herein, the brokered financial institution account is a cash account that is also earmarked for brokerage purchases, but wherein the customer can earn a higher interest rated than for the financial institution sweep account. A minimum amount of cash must be maintained in the brokered financial institution account. All transfers of cash into or out of the brokered financial institution account, except for the exception discussed earlier, are manual transfers that require the consent of the client. As discussed earlier herein, the exception permits an automatic withdrawal of cash from the brokered financial institution account when the cash is needed to complete a securities purchase.

At operation 802, a brokerage sweep account amount is identified for a customer of a financial institution. For this example, the financial institution is a chartered financial institution having three chartered entities. In addition, the financial institution can provide brokerage accounts to the customers of the financial institution. The brokerage accounts can be used to earn a higher interest rate on deposited cash that for a savings account or the financial institution sweep account. Yet the brokerage accounts can provide greater security for the client's cash than if the cash were kept in a money market fund.

At operation 804, a brokered financial institution account amount is identified for the customer. As discussed earlier herein, the brokered financial institution account can also be referred to as a financial institution deposit plus account.

At operation 806, the financial institution receives a request to purchase a security for a first dollar amount. For example, the request can be to purchase $2,000,000 of a specific stock.

At operation 808, a determination is made as to whether the brokerage sweep account amount is greater or equal to the first dollar amount.

At operation 810, when a determination is made that the brokerage sweep account amount is greater than or equal to the first dollar amount, at operation 812, the brokerage sweep account amount is used to purchase the security.

At operation 810, when a determination is made that the brokerage sweep account amount is less than the first dollar amount, at operation 814, the brokerage sweep account amount is used as partial payment for the security.

At operation 816, the brokerage sweep account amount is subtracted from the first dollar amount to form a second dollar amount.

At operation 818, the second dollar amount is automatically obtained from the brokered financial institution account. As discussed earlier herein, normally withdrawal of funds from the brokered financial institution account is a manual transaction that requires the consent of the customer. However, in this case the withdrawal of cash is used as a case reserve to supply funds that can be added to financial institution sweep cash to provide the funds needed to complete the purchase of the security. In this case, the withdrawal is an exception and an automatic withdrawal of funds can be used.

At operation 820, the second dollar amount is used to pay for the remainder of the security.

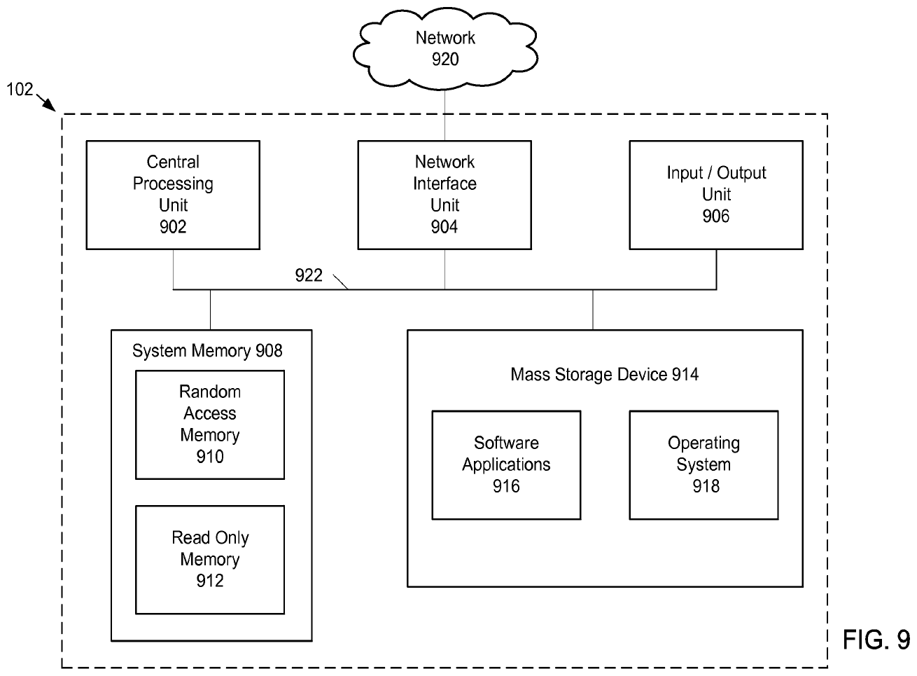

As illustrated in the example of FIG. 9, financial institution A computer system 102 includes at least one central processing unit (“CPU”) 902, a system memory 908, and a system bus 922 that couples the system memory 908 to the CPU 902. The system memory 908 includes a random access memory (“RAM”) 910 and a read-only memory (“ROM”) 912. A basic input/output system that contains the basic routines that help to transfer information between elements within the financial institution A computer system 102, such as during startup, is stored in the ROM 912. The financial institution A computer system 102 further includes a mass storage device 914. The mass storage device 914 is able to store software instructions and data. Some or all of the components of the financial institution A computer system 102 can also be included in financial institution B computer system 104, financial institution C computer system 106 and sweep management computer system 108.

The mass storage device 914 is connected to the CPU 902 through a mass storage controller (not shown) connected to the system bus 922. The mass storage device 914 and its associated computer-readable data storage media provide non-volatile, non-transitory storage for the financial institution A computer system 102. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial institution A computer system 102.

According to various embodiments of the invention, the financial institution A computer system 102 may operate in a networked environment using logical connections to remote network devices through the network 920, such as a wireless network, the Internet, or another type of network. The financial institution A computer system 102 may connect to the network 920 through a network interface unit 904 connected to the system bus 922. It should be appreciated that the network interface unit 904 may also be utilized to connect to other types of networks and remote computing systems. The financial institution A computer system 102 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the financial institution A computer system 102 can store software instructions and data. The software instructions include an operating system 918 suitable for controlling the operation of the financial institution A computer system 102. The mass storage device 914 and/or the RAM 910 also store software instructions, that when executed by the CPU 902, cause the financial institution A computer system 102 to provide the functionality of the financial institution A computer system 102 discussed in this document. For example, the mass storage device 914 and/or the RAM 910 can store software instructions that, when executed by the CPU 902, cause the financial institution A computer system 102 to display received data on the display screen of the financial institution A computer system 102.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device, the method comprising:
identifying a brokerage sweep account amount in a brokerage sweep account for a client, wherein the brokerage sweep account receives funds that are dedicated to purchasing securities;
identifying a brokered financial institution account amount for the client, the brokered financial institution account for the client paying a higher interest rate than the brokerage sweep account and the brokered financial institution account paying a higher interest rate than a standard savings account;
receiving a request to purchase a security; and
when the brokerage sweep account amount for the client is insufficient to purchase the security:
using the brokerage sweep account amount for the client as a partial payment for the security; and
using the brokered financial institution account amount to pay for a remainder of the security.

2. The method of claim 1, wherein the brokered financial institution account amount is equal to or greater than a predetermined minimum deposit amount required for the brokered financial institution account.

3. The method of claim 1, wherein a manual approval process is required before transferring funds to the brokerage financial institution account.

4. The method of claim 1, wherein the instructions further cause the processing unit to transfer cash from the brokerage sweep account to an interest bearing account at one or more chartered financial institutions.

5. The method of claim 4, wherein the instructions further cause the processing unit to transfer cash up to a Federal Deposit Insurance Corporation limit to one or more of the chartered financial institutions.

6. The method of claim 5, wherein the instructions further cause the processing unit to transfer any cash greater than a threshold amount to a first of the chartered financial institutions, the threshold amount being equal to the Federal Deposit Insurance Corporation limit multiplied by the number of chartered financial institutions.

7. The method of claim 1, wherein when the brokerage sweep account amount is less than a first amount, the instructions further cause the processing unit to transfer cash from the brokered financial institution account to one or more chartered financial institutions.

8. The method of claim 7, wherein a manual approval process is required before transferring the cash from the brokered financial institution account to the one or more chartered financial institutions.

9. The method of claim 7, wherein the instructions further cause the processing unit to transfer an amount of the cash equal to the Federal Deposit Insurance Corporation limit to one or more of the chartered financial institutions.

10. The method of claim 9, wherein the instructions further cause the processing unit to transfer any cash above a threshold amount to a first of the chartered financial institutions, the threshold amount being equal to the Federal Deposit Insurance Corporation limit multiplied by the number of chartered financial institutions.

11. A method implemented on an electronic computing device, the method comprising:
identifying a brokerage sweep account amount in a brokerage sweep account for a client, wherein the brokerage sweep account receives funds that are dedicated to purchasing securities;
identifying a brokered financial institution account amount for the client, the brokered financial institution account for the client paying a higher interest rate than the brokerage sweep account and the brokered financial institution account paying a higher interest rate than a standard savings account;
receiving a request to purchase a security for a first amount;
determining whether the brokerage sweep account amount for the client is equal to or greater than the first amount;
when the brokerage sweep account amount for the client is equal to or greater than the first amount:
obtaining the first amount from the brokerage sweep account;
using the first amount to pay for the security;
transferring cash from the brokerage sweep account to an interest bearing account at one or more chartered financial institutions; and
when the brokerage sweep account amount for the client is not equal to or greater than the first amount:
using the brokerage sweep account amount for the client as a partial payment for the security;
automatically obtaining a second amount from the brokered financial institution account for the client to fund a remainder of the first amount; and
using the second amount to pay for a remainder of the security.

12. The method of claim 11, further comprising transferring cash up to a Federal Deposit Insurance Corporation limit to the one or more of the chartered financial institutions.

13. The method of claim 12, further comprising transferring any cash greater than a third amount to a first of the chartered financial institutions, the third amount being equal to the Federal Deposit Insurance Corporation limit multiplied by the number of chartered financial institutions.

14. The method of claim 11, wherein the brokered financial institution account amount is equal to or greater than a predetermined minimum deposit amount required for the brokered financial institution account.

15. The method of claim 11, wherein when the brokerage sweep account amount is less than the first amount, the instructions further cause the processing unit to transfer cash from the brokered financial institution account to one or more chartered financial institutions.

16. The method of claim 15, wherein a manual approval process is required before transferring the cash from the brokered financial institution account to the one or more chartered financial institutions.

17. The method of claim 15, wherein the instructions further cause the processing unit to transfer an amount of the cash equal to the Federal Deposit Insurance Corporation limit to the one or more of the chartered financial institutions.

18. The method of claim 17, wherein the instructions further cause the processing unit to transfer any cash above a third amount to a first of the chartered financial institutions, the third amount being equal to the Federal Deposit Insurance Corporation limit multiplied by the number of chartered financial institutions.

19. A method implemented on an electronic computing device, the method comprising:
identifying a brokerage sweep account amount in a brokerage sweep account for a client, wherein the brokerage sweep account receives funds that are dedicated to purchasing securities;
identifying a brokered financial institution account amount for the client, the brokered financial institution account for the client paying a higher interest rate than the brokerage sweep account and the brokered financial institution account paying a higher interest rate than a standard savings account;
receiving a request to purchase a security for a first amount;
determining whether the brokerage sweep account amount for the client is equal to or greater than the first amount;
when the brokerage sweep account amount for the client is equal to or greater than the first amount:
obtaining the first amount from the brokerage sweep account;
using the first amount to pay for the security; and
transferring cash from the brokerage sweep account to an interest bearing account at one or more chartered financial institutions; and
when the brokerage sweep account amount for the client is less than the first amount:
using the brokerage sweep account amount for the client as a partial payment for the security;
automatically obtaining a second amount from the brokered financial institution account for the client to fund a remainder of the first amount;
using the second amount to pay for a remainder of the security; and
transferring an amount of cash, equal to the Federal Deposit Insurance Corporation limit, from the brokered financial institution account to one or more chartered financial institutions.

20. The method of claim 19, further comprising transferring any cash above a third amount to a first of the chartered financial institutions, the third amount being equal to the Federal Deposit Insurance Corporation limit multiplied by the number of chartered financial institutions.
